(19) United States
(12) Patent Application Publication
(10) Pub. No.: US 2017/0018835 A1
(43) Pub. Date: Jan. 19, 2017

(54) ANTENNA CONTROL CIRCUIT AND ANTENNA CONTROL METHOD

(71) Applicant: HTC Corporation, Taoyuan City (TW)

(72) Inventors: Chung-Chi Lai, Taoyuan City (TW); Wei-Yang Wu, Taoyuan City (TW); Tiao-Hsing Tsai, Taoyuan City (TW)

(21) Appl. No.: 14/801,843

(22) Filed: Jul. 17, 2015

(51) Int. Cl. H01Q 1/22

(52) U.S. Cl. CPC H01Q 1/22

(57) ABSTRACT

An antenna control circuit and a corresponding antenna control method are provided. The antenna control circuit includes an antenna and a diode. An anode of the diode is coupled to the antenna. A cathode of the diode is grounded. The anode receives a negative voltage when the antenna receives an alternating current (AC) voltage signal. The antenna control circuit and the antenna control method can increase antenna bandwidth by switching the diode. In addition, the antenna control circuit and the antenna control method can provide better radiation efficiency.

### BACKGROUND OF THE INVENTION

Field of the Invention

The disclosure relates to an antenna, and more particularly, to an antenna control circuit and a corresponding antenna control method.

Description of Related Art

Mobile devices are capable of providing convenient functions of wireless communication. There are various wireless communication standards each uses a corresponding frequency band. With increasing numbers of the frequency bands being used by the mobile device each day, design requirements for antenna bandwidth also become higher. As such, the traditional passive antenna design can no longer satisfy the requirements.

### SUMMARY OF THE INVENTION

The disclosure is directed to an antenna control circuit and an antenna control method in order to solve aforesaid issues regarding requirements for the antenna bandwidth.

The antenna control circuit of the disclosure includes an antenna and a diode.

An anode of the diode is coupled to the antenna. A cathode of the diode is grounded. The anode receives a negative voltage when the antenna receives an alternating current (AC) voltage signal.

The antenna control method of the disclosure includes: providing a negative voltage to an anode of a diode when an antenna receives an alternating current voltage signal. Herein, the anode is coupled to the antenna, and a cathode of the diode is grounded.

The antenna control circuit and the antenna control method can increase antenna bandwidth by switching the diode. In addition, the antenna control circuit and the antenna control method can provide better radiation efficiency.

To make the above features and advantages of the present disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating an antenna control circuit according to an embodiment of the disclosure.

FIG. 2 is a schematic diagram illustrating an antenna control method according to an embodiment of the disclosure.

FIG. 3 is a schematic diagram illustrating an equivalent circuit of an antenna control circuit according to an embodiment of the disclosure.

FIG. 4 is a schematic diagram illustrating an equivalent circuit of an antenna control circuit according to an embodiment of the disclosure.

FIG. 5 is a schematic diagram illustrating the alternating current voltage signal of the antenna control circuit according to an embodiment of the disclosure.

FIG. 6 is a schematic diagram illustrating the anode voltage of the diode in the antenna control circuit according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

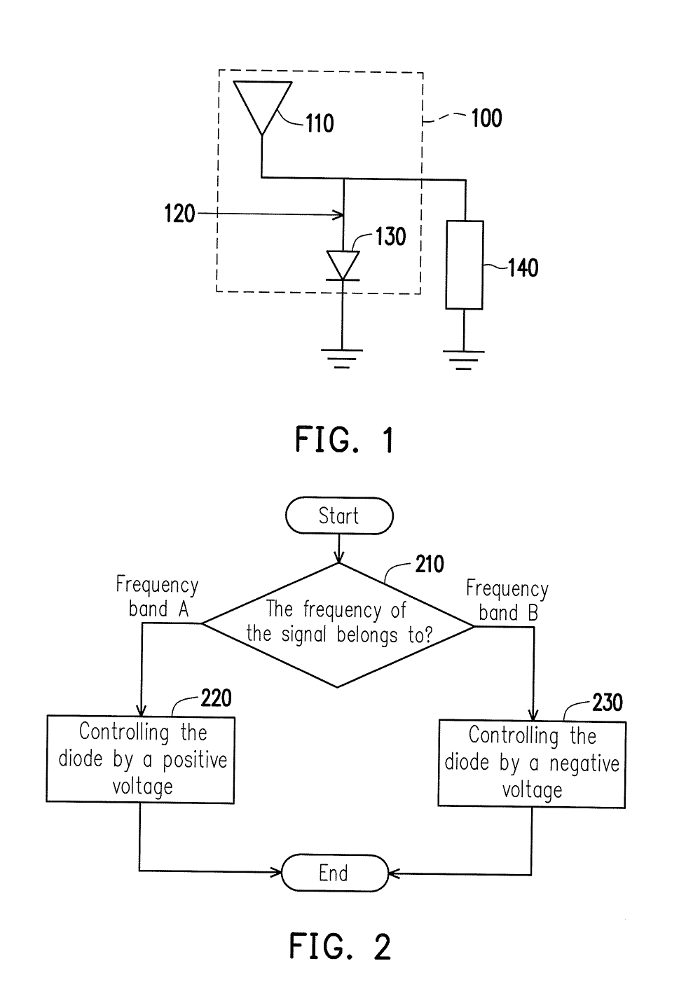

FIG. 1 is a schematic diagram illustrating an antenna control circuit 100 according to an embodiment of the disclosure. The antenna control circuit 100 includes an antenna 110 and a diode 130. A feed point of the antenna 110 is coupled to an anode of the diode 130 and a system end 140. A cathode of the diode 130 is grounded. The antenna control circuit 100 may be a part of a mobile device such as a smart phone, a personal digital assistant (PDA) or a tablet computer. The system end 140 may be a main system circuit of the mobile device. The system end 140 is a load of the antenna control circuit 110 as well as a source of signals transmitted by the antenna 110.

The anode of the diode 130 receives a control voltage 120. Based on the different values of the control voltages 120, the diode 130 may be in either on-state or cutoff-state. This characteristic of the diode 130 may increase a bandwidth of the antenna 110, so that the antenna may provide preferable performance in both two of preset frequency bands A and B. Such antenna may be used in the latest wireless communication technology such as Long Term Evolution (LTE).

FIG. 2 is a schematic diagram illustrating an antenna control method according to an embodiment of the disclosure. The antenna control method may be performed by using the antenna control circuit 100. The system end 140 may provide an alternating current voltage signal 350. The antenna 110 receives and transmits the alternating current voltage signal 350. The alternating current voltage signal 350 may be a radio-frequency signal. First of all, in step 210, whether a frequency of the alternating current voltage signal 350 belongs to the frequency band A or belongs to the frequency band B is checked.

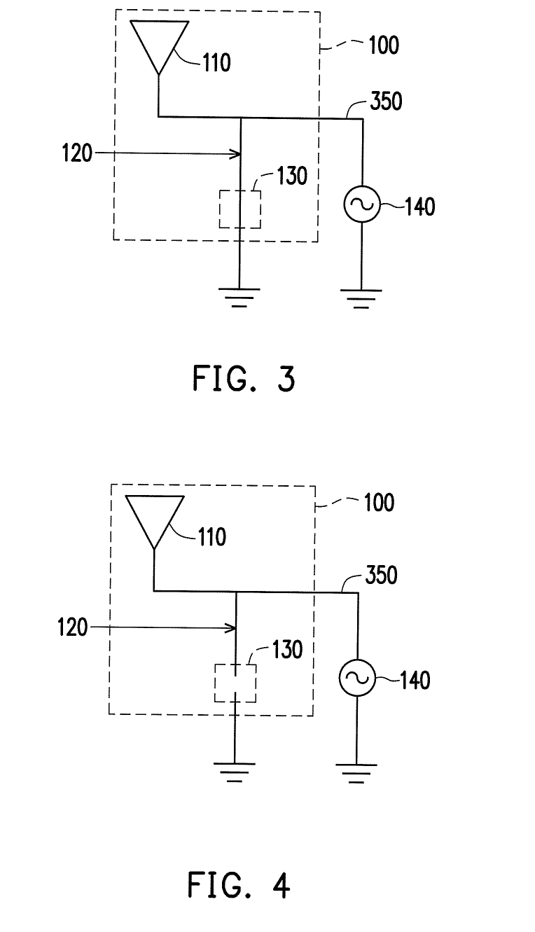

If the frequency of the alternating current voltage signal 350 belongs to the frequency band A, the control voltage 120 with a positive value (e.g., 0.8V or a higher voltage) is provided to the anode of the diode 130 in step 220, so as to control the diode 130 to enter the on-state. In this case, the equivalent circuit of the antenna control circuit 100 is as shown by FIG. 3. At this time, the diode 130 is equivalent to short circuit, and based on the main body design of the antenna 110, the alternating current voltage signal 350 passes through short circuit of diode 130, so that a preferable radiation efficiency may be provided to the antenna 110 at the frequency band A.

If the frequency of the alternating current voltage signal 350 belongs to the frequency band B, the control voltage 120 with a negative value is provided to the anode of the diode 130 in step 230, so as to control the diode 130 to enter the cutoff-state. In this case, the equivalent circuit of the antenna control circuit 100 is as shown by FIG. 4. At this time, the diode 130 is equivalent to open circuit, and based on the main body design of the antenna 110, the alternating current voltage signal 350 passes through a longer path, so that a preferable radiation efficiency may be provided to the antenna 110 at the frequency band B.

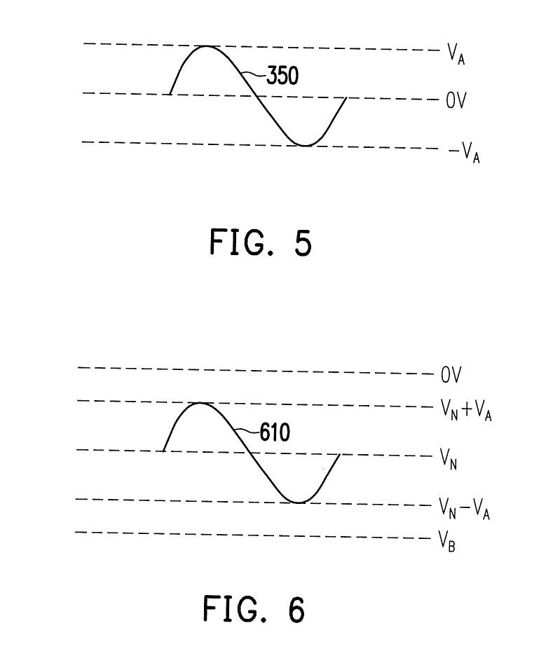

FIG. 5 is a schematic diagram illustrating the alternating current voltage signal 350 according to an embodiment of the disclosure, wherein V_{A} is an amplitude of the alternating current voltage signal 350. For simplicity, the alternating current voltage signal 350 is illustrated as a sinusoidal wave. In another embodiment, the alternating current voltage signal 350 may be an alternating current voltage signal in any forms.

In the traditional technologies, the diode is controlled to enter the cutoff-state by using a ground voltage (0V). According to the traditional technologies, the alternating current voltage signal 350 is regarded as an anode voltage of the diode 130. If the amplitude of the alternating current voltage signal 350 is overly large, a voltage value of the alternating current voltage signal 350 in a positive half-period may approach or exceed a forward biased voltage of the diode to partially turn-on or complete turn-on the diode 130. In a negative half-period of the alternating current voltage signal 350, the diode 130 enters the cutoff-state. The antenna may be interfered by switching the diode 130 between the on-state and the cutoff-state to increase the radiated spurious emission (RSE) of the antenna.

Therefore, the negative voltage is used to control the diode to enter the cutoff-state in an embodiment of the disclosure. FIG. 6 is a schematic diagram illustrating an anode voltage 610 of the diode 130 according to the preset embodiment. V_{N} in FIG. 6 is the negative voltage in step 230, namely, the control voltage 120 provided in step 230. V_{B} is a reverse breakdown voltage of the diode 130. The anode voltage 610 of the diode 130 is a superposition result of the alternating current voltage signal 350 and the negative voltage V_{N}.

The anode voltage 610 of the diode 130 does not exceed the ground voltage 0V in the present embodiment. In view of FIG. 6, the negative voltage V_{N} is determined according to the amplitude V_{A} of the alternating current voltage signal 350. Because V_{N}+V_{A} is less than or equal to 0V, the negative voltage V_{N} is less than or equal to −V_{A}. On the other hand, in order to prevent the reverse breakdown of the diode 130, V_{N} −V_{A} is greater than V_{B}, such that the negative voltage V_{N} is greater than a sum of the reverse breakdown voltage V_{B} of the diode 130 and the amplitude V_{A} of the alternating current voltage signal 350.

In the present embodiment, the negative voltage is used to control the diode 130 so as to ensure that the diode 130 constantly stays in the cutoff-state by maintaining the anode voltage 610 between the ground voltage 0V and the reverse breakdown voltage V_{B}. Accordingly, the diode 130 may be prevented form being turned-on while reducing the radiated spurious emission of the antenna. As a result, because the on-state and the cutoff-state of diode 130 can provide preferable performance in both of the frequency bands, the bandwidth of the antenna 110 may expanded.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An antenna control circuit, comprising:
an antenna; and
a diode, wherein an anode of the diode is coupled to the antenna, a cathode of the diode is grounded, and the anode receives a negative voltage when the antenna receives an alternating current voltage signal.

2. The antenna control circuit of claim 1, wherein the negative voltage is determined according to an amplitude of the alternating current voltage signal.

3. The antenna control circuit of claim 2, wherein the negative voltage is less than or equal to a negative value of the amplitude of the alternating current voltage signal.

4. The antenna control circuit of claim 2, wherein the negative voltage is greater than a sum of a reverse breakdown voltage of the diode and the amplitude of the alternating current voltage signal.

5. The antenna control circuit of claim 1, wherein the anode receives a positive voltage when a frequency of the alternating current voltage signal belongs to a first frequency band, and the anode receives the negative voltage when the frequency of the alternating current voltage signal belongs to a second frequency band.

6. An antenna control method, comprising:
providing a negative voltage to an anode of a diode when an antenna receives an alternating current voltage signal, wherein the anode is coupled to the antenna, and a cathode of the diode is grounded.

7. The antenna control method of claim 6, wherein the negative voltage is determined according to an amplitude of the alternating current voltage signal.

8. The antenna control method of claim 7, wherein the negative voltage is less than or equal to a negative value of the amplitude of the alternating current voltage signal.

9. The antenna control method of claim 7, wherein the negative voltage is greater than a sum of a reverse breakdown voltage of the diode and the amplitude of the alternating current voltage signal.

10. The antenna control method of claim 6, further comprising:
providing a positive voltage to the anode when a frequency of the alternating current voltage signal belongs to a first frequency band; and
providing the negative voltage to the anode when the frequency of the alternating current voltage signal belongs to a second frequency band.
